(19) United States
(12) Patent Application Publication
(10) Pub. No.: US 2026/0038715 A1
(43) Pub. Date: Feb. 5, 2026

(54) COMMUNICATION CABLE AND A METHOD OF ROUTING SAME

(71) Applicant: Yazaki Corporation, Tokyo (JP)

(72) Inventors: Tomomi YOSHIMI, Shizuoka (JP); Shuichi INOUE, Shizuoka (JP)

(73) Assignee: Yazaki Corporation, Tokyo (JP)

(21) Appl. No.: 19/284,941

(22) Filed: Jul. 30, 2025

(30) Foreign Application Priority Data
Aug. 1, 2024 (JP) 2024-125718

(51) Int. Cl. H01B 11/12

(52) U.S. Cl. CPC H01B 11/12

(57) ABSTRACT

A communication cable includes: a twisted wire obtained by twisting two insulated electric wires each having a conductor cross-sectional area of 0.13 to 0.35 sq; and a sheath configured to coat an outer periphery of the twisted wire, wherein a twist pitch of the twisted wire is within a range from 25 to 37.5 mm. A characteristic impedance is preferably 100±10 Ω.

### CROSS-REFERENCE TO RELATED APPLICATIONS

The present application is based on, and claims priority from the prior Japanese Patent Application No. 2024-125718, filed on Aug. 1, 2024, the entire contents of which are incorporated herein by reference.

### TECHNICAL FIELD

The present disclosure relates to a communication cable and a method of routing the communication cable.

### BACKGROUND

For two-core differential transmission cables used for automotive communication cables, for example, cables used for Ethernet communication, it is required to strictly control characteristic impedances. Meanwhile, a conventional communication cable prevents loosening of a twist structure by keeping a twist pitch below a certain range, and minimizes variations and changes with time in transmission characteristics for characteristic impedances (see JP2020-181821 A).

### SUMMARY OF THE INVENTION

Although the communication cable described in JP2020-181821 A contributes to manufacturability and communication performance stability, superiority with regard to EMC performance is not considered. In addition, it is known that electromagnetic induction occurs in unshielded type communication cables when there is a transmission path where an AC signal flows in the vicinity, which affects communication performance. In particular, when the twist pitches are identical to each other, its induction amount increases, and communication may not be established. Furthermore, when the twist pitch is excessively small, there is an issue that each electric wire has a strong twist that remains during terminal processing, and terminal processing efficiency decreases.

The present disclosure has been made in view of such problems in the conventional technology. It is an object of the present disclosure to provide a communication cable excellent in noise resistance, manufacturability, and terminal processability, and a method of routing the communication cable.

A communication cable according to a first embodiment of the present disclosure includes: a twisted wire obtained by twisting two insulated electric wires each having a conductor cross-sectional area of 0.13 to 0.35 sq; and a sheath configured to coat an outer periphery of the twisted wire, wherein a twist pitch of the twisted wire is within a range from 25 to 37.5 mm.

A method of routing a communication cable according to a second embodiment of the present disclosure is a method of routing at least two communication cables: a communication cable A including a twisted wire obtained by twisting two insulated electric wires each having a conductor cross-sectional area of 0.13 to 0.35 sq, and a sheath coating an outer periphery of the twisted wire; and a communication cable B including a twisted wire obtained by twisting two insulated electric wires each having a conductor cross-sectional area of 0.13 to 0.35 sq, and a sheath coating an outer periphery of the twisted wire, the method comprising: routing the communication cable A and the communication cable B in parallel at a distance of less than 30 mm, wherein a difference between a twist pitch of the twisted wire of the communication cable A and a twist pitch of the twisted wire of the communication cable B is set to 2 mm or more.

According to the present disclosure, it is possible to provide a communication cable excellent in noise resistance, manufacturability, and terminal processability, and a method of routing the communication cable.

### BRIEF DESCRIPTION OF DRAWINGS

FIG. 1 is a cross-sectional view of a communication cable according to the present embodiment.

FIG. 2 is a side view illustrating part of a twisted wire in the communication cable according to the present embodiment.

FIG. 3 is a graph illustrating induction amount relative to transmission frequency, by twist pitch.

FIG. 4 is a graph illustrating twist processing cost relative to twist pitch.

FIG. 5 is a graph illustrating a settable range of twist pitches, based on twist processing cost relative to twist pitch, and induction amount relative to twist pitch.

FIG. 6 is a graph illustrating degree of ground equilibrium (LCTL; Longitudinal Conversion Transfer Loss) relative to transmission frequency.

FIG. 7 is a graph illustrating near-end crosstalk relative to transmission frequency, by twist pitch difference.

### DETAILED DESCRIPTION OF THE INVENTION

Hereinafter, a communication cable and a method of routing the communication cable according to the present embodiment will be described in detail with reference to the drawings. Note that the dimensional ratios in the drawings are exaggerated for convenience of the description and are sometimes different from actual ratios.

### Communication Cable

The communication cable of the present embodiment has a twisted wire formed by twisting two insulated electric wires having a conductor cross-sectional area of 0.13 to 0.35 sq, and a sheath coating the outer periphery of the twisted wire, and a twist pitch of the twisted wire is within a range from 25 to 37.5 mm. Note that the conductor cross-sectional area of 0.13 to 0.35 sq is specified in ISO 21111-8.

By setting the twist pitch of the twisted wire to 25 to 37.5 mm, the communication cable of the present embodiment is excellent in noise resistance, and excellent in manufacturability and terminal processability. More specifically, by setting the twist pitch of the twisted wire to 25 to 37.5 mm, an appropriate induction amount can be ensured, and thus noise resistance is excellent. Moreover, since the twist pitch has an appropriate length, processing efficiency can be improved. The communication cable of the present embodiment will be described in detail below.

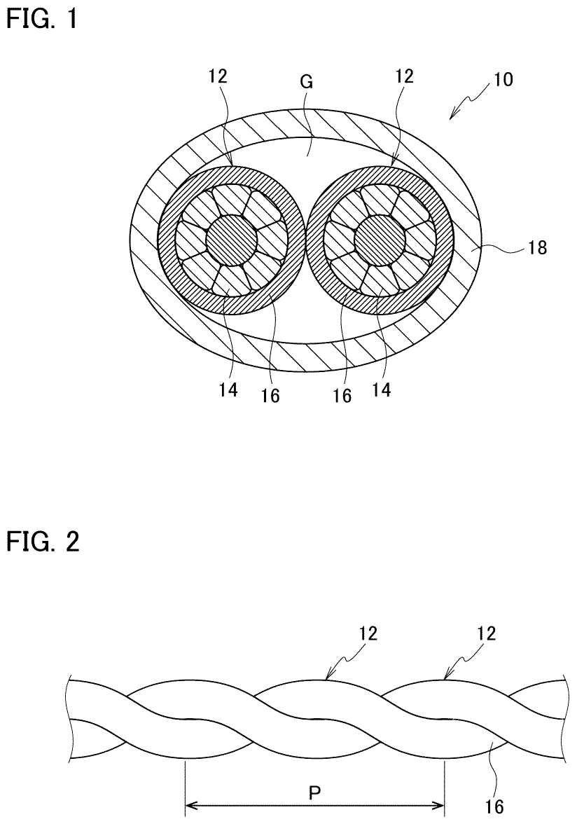

FIG. 1 is a cross-sectional view illustrating an example of the communication cable of the present embodiment. A communication cable 10 illustrated in FIG. 1 includes, as a communication line, a twisted wire formed by twisting a pair of insulated electric wires 12, 12. Each insulated electric wire 12 has a conductor 14, and an insulating coating 16 coating the outer periphery of the conductor 14. The communication cable 10 includes a sheath 18 which is made from an insulating material and coats the outer periphery of the entirety of the twisted wire. The sheath 18 continuously surrounds the outer periphery of the twisted wire over the entire circumference about a longitudinal axis thereof. In FIG. 1, a gap is provided between the insulated electric wire 12 and the sheath 18, but the sheath 18 may be configured to have a structure that fills the gap. That is, the outer surface of the insulated electric wire 12 may be configured to be directly coated with the sheath 18.

The insulated electric wire has a conductor cross-sectional area of 0.13 to 0.35 sq. The strength of the wire is weakened when the area is less than 0.13 sq, and the wire cannot be twisted at a specified pitch when the area is more than 0.35 sq.

Here, twist pitch will be described. As illustrated in FIG. 2, a twist pitch P of a twisted wire is one cycle of twisting of the insulated electric wire 12, and is defined as a length of the one cycle of twisting of insulated electric wire 12 in a longitudinal direction.

In the communication cable of the present embodiment, by setting the twist pitch of the twisted wire to a range from 25 to 37.5 mm as described above, the communication cable is excellent in noise resistance, manufacturability, and terminal processability. The reason for this will be explained below.

In order to reduce an induced voltage generated on the communication line side by a magnetic flux emitted from the insulated electric wire, it is effective to pair-twist two insulated electric wires to form a twisted pair structure. The twisted pair structure cancels the induced voltage generated, and reduces noise. Table 1 below lists a noise reduction ratio of twisted wires having different twist pitches (source: THE NIKKAN KOGYO SHIMBUN, LTD., “Noise Countermeasure Handbook”). More specifically, the noise reduction ratio (ratio and dB) is illustrated for twisted wires each having twist pitches of 4 inches (˜100 mm), 3 inches (˜75 mm), 2 inches (˜50 mm), and 1 inch (˜25 mm), and a parallel wire. As listed in Table 1, a noise reduction effect increases as the twist pitch decreases. However, when the twist pitch is excessively small, cost increases due to a decrease in productivity of communication cables, and a twist ratio of wire cores increases. Thus, there are other side effects such as an increase in conductor resistance. Therefore, it is important to consider a cost-effectiveness balance when setting the twist pitch.

TABLE 1

| | Twist pitch | | Noise reduction ratio | |
|---|---|---|---|---|
| Sample on induced side | [inch] | | Ratio | dB |
| Parallel wires | — | | 1:1 | 0 |
| Twisted wire | 4(≈100 | mm) | 14:1 | 23 |
| Twisted wire | 3(≈75 | mm) | 71:1 | 37 |
| Twisted wire | 2(≈50 | mm) | 112:1 | 41 |
| Twisted wire | 1(≈25 | mm) | 141:1 | 43 |

| | | |
|---|---|---|
| Parallel wires in 1-inch electrical conduit | 22:1 | 27 |

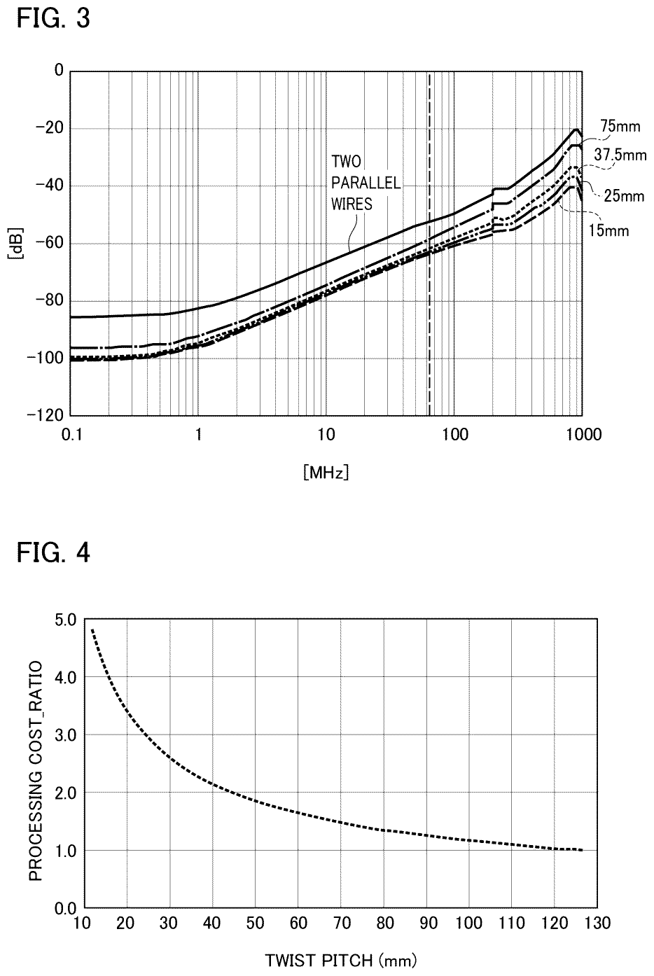

Meanwhile, FIG. 3 illustrates a graph of simulation results of induction amounts relative to transmission frequencies of twisted wires having twist pitches of 15 mm, 25 mm, 37.5 mm, and 75 mm. In this simulation, a signal was input to twisted pair wires having different twist pitches using electromagnetic field analysis software, the dielectric amount corresponding to the signal was measured, and a graph was created. Then, based on the graph created, a signal was input to each twisted pair wire, and the dielectric amount generated by induction from the twisted pair wire was obtained through simulation. The simulation result illustrated in FIG. 3 indicates that there is no significant change in the induction amount with a twist pitch of 15 to 37.5 mm. When the twist pitch exceeds 37.5 mm, the induction amount increases, which adversely affects a peripheral transmission line where an AC signal flows.

In addition, twist processing cost against the twist pitch is examined. FIG. 4 is a graph illustrating the twist processing cost against the twist pitch. As illustrated in FIG. 4, the longer the twist pitch, the higher the manufacturing efficiency and the fewer the amount of required members, and thus the cable cost can be reduced. On the other hand, the shorter the twist pitch, the higher the material weight per unit length, and thus the cost increases.

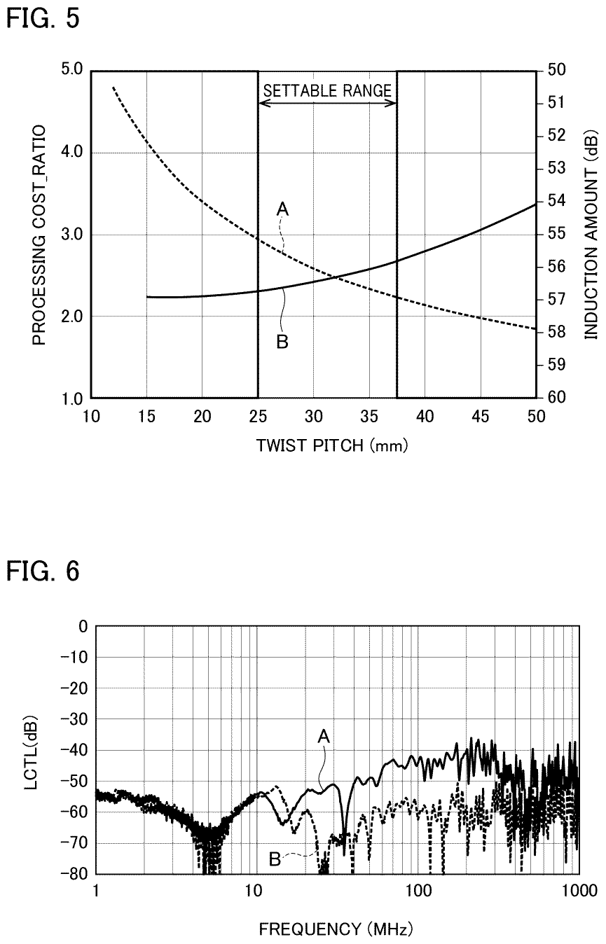

It is considered that by examining the above contents of both FIG. 3 and FIG. 4, a twist pitch range of a twisted wire can be obtained where the twist processing cost can be reduced, and the increase of the induction amount can be controlled. Thus, FIG. 5 illustrates a graph where the horizontal axis of the graph illustrated in FIG. 3 is the twist pitch, and the graph illustrated in FIG. 4 is simultaneously drawn. In FIG. 5, A corresponds to the graph illustrated in FIG. 4, and B corresponds to the graph illustrated in FIG. 3, where the horizontal axis is the twist pitch. It is evident from FIG. 5 that the twist pitch range of a twisted wire is within a range from 25 to 37.5 mm where the induction amount does not increase, and the twist processing cost is reduced. The twist pitch range is illustrated as “settable range” in FIG. 5.

For the above reason, in the communication cable of the present embodiment, the twist pitch of the twisted wire is set to a range from 25 to 37.5 mm. When the twist pitch of a twisted wire is less than 25 mm, there is a strong twist when unwinding the twisted wire during terminal processing, and processing efficiency decreases. When the twist pitch is more than 37.5 mm, the induction amount increases, and there is a possibility of adversely affecting a peripheral communication circuit. In addition, after pair-twist processing, drum winding is performed to form a sheath by extrusion molding, and the twist breaks down at this time. When the twist breaks down, the distance between two wires becomes unstable, and communication performance decreases.

Furthermore, considering a case where the communication cable of the present embodiment is installed in an automobile, it is preferable that the twist pitch of the twisted wire be 27 mm or more, as described below. In general, when a transmission path where an AC signal flows is routed in the periphery of an unshielded type cable in a range of less than 30 mm, a phenomenon called crosstalk is observed, which affects each other's communication and degrades communication quality. For crosstalk, the closer the twist pitches are to each other, the more likely resonance is to occur, tending to increase influence. FIG. 6 is a graph illustrating a degree of equilibrium (LCTL) relative to transmission frequencies, where A is when in contact with a measurement target, and B is when 30 mm or more away from a measurement target. It is evident from FIG. 6 that the communication quality is lower in A when in contact with a measurement target.

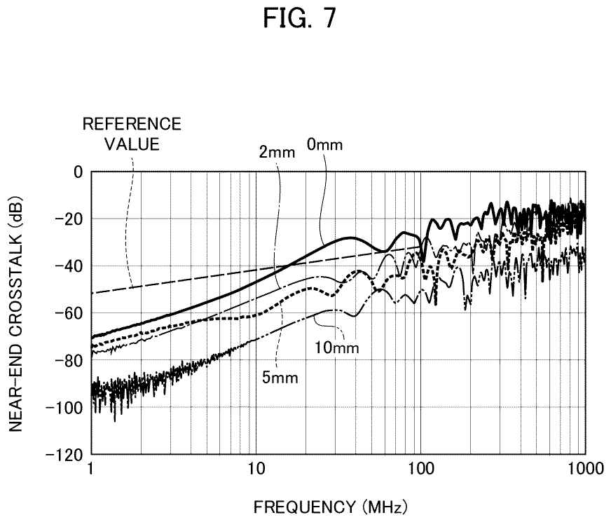

When routed in automobiles, communication cables are bundled, and the distance between them is 30 mm or less in most cases. In addition, many unshielded twisted wires for CAN (Controller Area Network), which is an in-vehicle network, are already used in automobiles. Since such cables are designed for higher-speed communication, the influence of the twisted wires is life threatening to the communication quality. In order to eliminate such danger, it is preferable to use a twist pitch different from the twist pitch of the above twisted wires. More specifically, since the twist pitch of unshielded twisted wires for CAN is 20 to 30 mm according to the official standard (SAE Standard J2284), it is preferable to set a twist pitch that deviates from the median of the range of 25 mm. Here, a graph illustrating near-end crosstalk relative to transmission frequencies by differences in twist pitches of twisted wires is illustrated in FIG. 7. The graph in FIG. 7 illustrates cases where differences in twist pitches of twisted wires are 0 mm, 2 mm, 5 mm, and 10 mm, respectively. It is evident from FIG. 7 that the longer the difference in twist pitch between twisted wires, the lower the near-end crosstalk. From the above, it is preferable to have 2 mm or more away from the median twist pitch of 25 mm of unshielded twisted wires for CAN. When the difference in twist pitch between communication wires is less than 2 mm, the mutual resonance is strong, and a crosstalk reference is not satisfied. Therefore, in the present embodiment, it is preferable that the twist pitch be 27 mm or more.

In the communication cable of the present embodiment, it is preferable that the twist pitch of twisted wires be 34 mm or less. It can be confirmed from FIG. 7 that the longer the difference in twist pitch between twisted wires, the less the amount of crosstalk. However, when the twist pitch is more than 34 mm, unevenness when viewed in the longitudinal direction is reduced, and adhesion with a sheath is rapidly impaired, and thus coming off from the sheath may occur during peeling of the twisted wire. Therefore, it is preferable that the twist pitch of the twisted wires be 34 mm or less.

The communication cable of the present embodiment preferably has a characteristic impedance in a range of 100±10 Ω. The characteristic impedance of 100±10 Ω is typically required for an insulated electric wire for Ethernet communication. With such characteristic impedance, the communication cable can be suitably used for high-speed communication in an automobile or the like.

Next, elements of the communication cable of the present embodiment will be each described in detail.

The insulated electric wire includes a conductor, and an insulating coating that coats the conductor and is made from an insulator. The conductor may be composed of only one strand or may be a combined twisted wire composed of multiple strands. In addition, the conductor may be composed of only one twisted wire or may be a combined twisted wire composed of multiple twisted wires. Furthermore, the conductor may be a circular compressed conductor or a circular conductor. A material forming the conductor is not particularly limited but is preferably at least one conductive metal material selected from the group consisting of copper, copper alloy, aluminum, and aluminum alloy.

The outer diameter of the conductor is not particularly limited, but is preferably 0.435 mm or more, and more preferably 0.440 mm or more. By setting the diameter of the conductor as described above, resistance of the conductor can be reduced. The diameter of the conductor is not particularly limited, but is preferably 0.465 mm or less, and more preferably 0.460 mm or less. By setting the outer diameter of the conductor as described above, routing of the insulated electric wire can be facilitated even in narrow and short paths.

A material of the insulating coating is not particularly limited as long as electrical insulation of the conductor can be ensured. As a base resin forming the insulating coating, an olefin resin, such as cross-linked polyethylene and polypropylene, or an electrically insulating resin, such as vinyl chloride resin, can be optionally used. Specifically, examples of the base resin forming the insulating coating used include polyvinyl chloride, heat-resistant polyvinyl chloride, cross-linked polyvinyl chloride, polyethylene, cross-linked polyethylene, foamed polyethylene, cross-linked foamed polyethylene, chlorinated polyethylene, polypropylene, polyamide (nylon), polyvinylidene fluoride, ethylene-tetrafluoroethylene copolymer, ethylene-tetrafluoroethylene-hexafluoropropylene copolymer, ethylene tetrafluoroethylene, perfluoroalkoxy alkane, natural rubber, chloroprene rubber, butyl rubber, ethylene propylene rubber, chlorosulfonated polyethylene rubber, and silicone rubber. One of these materials may be used alone, or two or more may be used in combination.

Examples of the polypropylene resin used for the base resin forming the insulating coating include homopolypropylene (homoPP), random polypropylene (random PP), block polypropylene (block PP), and copolymers with components copolymerizable with propylene, such as other olefins. Examples of other olefins copolymerizable with propylene include a-olefins such as ethylene, 1-butene, isobutylene, 1-pentene, 3-methyl-1-butene, 1-hexene, 3,4-dimethyl-1-butene, 1-heptene, and 3-methyl-1-hexene.

The thickness of the insulating coating is not particularly limited but is preferably 0.15 mm or more, and more preferably 0.18 mm or more. By setting the thickness of the insulating coating as described above, conductors can be effectively protected. The thickness of the insulating coating is not particularly limited but is preferably 0.32 mm or less. By making the thickness of the insulating coating as described above, routing of insulated electric wires can be facilitated even in narrow paths.

As described above, the twisted wire is obtained by twisting two insulated electric wires to have a twist pitch in a predetermined range.

The sheath is an insulating member coating the periphery of the twisted wire and is configured by polyolefin or the like, for example.

The communication cable of the present embodiment can be produced using a known method, for example, a general extrusion method. Specifically, after twisting two insulated electric wires, a sheath can be formed by extruding a sheath material to coat the outer surface of the insulated electric wires.

### Method of Routing Communication Cable

The method of routing the communication cable of the present embodiment is a method of routing at least two communication cables A and B below.

The communication cable A includes a twisted wire obtained by twisting two insulated electric wires having a conductor cross-sectional area of 0.13 to 0.35 sq, and a sheath coating the outer periphery of the twisted wire.

The communication cable B includes a twisted wire obtained by twisting two insulated electric wires having a conductor cross-sectional area of 0.13 to 0.35 sq, and a sheath coating the outer periphery of the twisted wire.

The difference between a twist pitch of the twisted wire of the communication cable A and a twist pitch of the twisted wire of the communication cable B is set to 2 mm or more. In addition, the communication cable A and the communication cable B are routed in parallel at a distance of less than 30 mm.

As described above, when a transmission path where an AC signal flows is routed in the periphery of an unshielded type cable in a range of less than 30 mm, a phenomenon called crosstalk is observed, which affects each other's communication and degrades communication quality. From this viewpoint, when two communication cables are routed, it is preferable to keep a distance of 30 mm or more from each other. However, as described above, when communication cables are routed in an automobile, communication cables are bundled, and the distance therebetween is usually 30 mm or less. Thus, in the present embodiment, assuming a case where it is difficult to route communication cables with a distance of 30 mm or more, such as in an automobile, the occurrence of crosstalk is controlled by separating adjacent communication cables by 2 mm or more.

In the method of routing the communication cable of the present embodiment, both of the communication cables A and B are the communication cable of the present embodiment described above. Thus, the description will be omitted here.

In the method of routing the communication cable of the present embodiment, when the communication cable A and the communication cable B are routed in parallel at a distance of less than 30 mm, the difference between the twist pitch of the twisted wire of the communication cable A and the twist pitch of the twisted wire of the communication cable B is set to 2 mm or more. When the difference between the twist pitches is less than 2 mm, mutual resonance is strong, and a crosstalk standard is not satisfied. The difference between the twist pitches is preferably 2 mm or more, and more preferably 5 mm or more. Note that the upper limit of the difference between the twist pitches is 12.5 mm.

As described above, the method of routing the communication cable of the present embodiment can control the occurrence of crosstalk when routing at least two communication cables.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication cable, comprising:
a twisted wire obtained by twisting two insulated electric wires each having a conductor cross-sectional area of 0.13 to 0.35 sq; and
a sheath configured to coat an outer periphery of the twisted wire, wherein
a twist pitch of the twisted wire is within a range from 25 to 37.5 mm.

2. The communication cable according to claim 1, wherein a characteristic impedance of the communication cable is 100±10 Ω.

3. A method of routing at least two communication cables, the at least two communication cables including: a communication cable A including a twisted wire obtained by twisting two insulated electric wires each having a conductor cross-sectional area of 0.13 to 0.35 sq, and a sheath coating an outer periphery of the twisted wire; and a communication cable B including a twisted wire obtained by twisting two insulated electric wires each having a conductor cross-sectional area of 0.13 to 0.35 sq, and a sheath coating an outer periphery of the twisted wire, the method comprising:
routing the communication cable A and the communication cable B in parallel at a distance of less than 30 mm, wherein
a difference between a twist pitch of the twisted wire of the communication cable A and a twist pitch of the twisted wire of the communication cable B is set to 2 mm or more.
